(19) United States
(12) Patent Application Publication
(10) Pub. No.: US 2025/0287090 A1
(43) Pub. Date: Sep. 11, 2025

(54) DISPLAY CONTROL APPARATUS, METHOD FOR CONTROLLING DISPLAY CONTROL APPARATUS, AND STORAGE MEDIUM

(71) Applicant: CANON KABUSHIKI KAISHA, Tokyo (JP)

(72) Inventor: MOTOYUKI ASANO, Tokyo (JP)

(21) Appl. No.: 19/065,995

(22) Filed: Feb. 27, 2025

(30) Foreign Application Priority Data
Mar. 5, 2024 (JP) 2024-033088

(51) Int. Cl. H04N 23/611; H04N 23/63; H04N 23/67

(52) U.S. Cl. CPC H04N 23/611; H04N 23/635; H04N 23/675

(57) ABSTRACT

A display control apparatus includes one or more processors that execute a program stored in a memory and thereby function as: a display control unit that performs control such that a live view image being captured by an imaging unit is displayed and such that a display item indicating a degree of focus is superimposed on the live view image; a detection unit capable of detecting parts of a subject in the live view image; an acquisition unit that acquires a focus detection result for a focus detection region corresponding to a position at which the display item is displayed; and a changing unit that changes a display mode of the display item based on the focus detection result acquired by the acquisition unit. The display control unit changes a responsiveness with which the display item is displayed in accordance with a part detected by the detection unit.

### BACKGROUND OF THE DISCLOSURE

### Field of the Disclosure

The present disclosure relates to a display control apparatus, a method for controlling the display control apparatus, and a storage medium, and more particularly to a technology for displaying information related to focusing.

### Description of the Related Art

Display devices have been proposed that display whether a subject whose image is being captured is in front focus or back focus as well as the degree of defocus based on information acquired from an image sensor regarding the degree to which the subject is in focus.

Japanese Patent Laid-Open No. 2016-197180 proposes a display that enables recognition of whether the focus state is front focus, back focus, or in-focus based on the information regarding the degree to which a subject is in focus.

Japanese Patent Laid-Open No. 2016-197231 describes a display control apparatus including a focus detector that detects an amount of defocus and a direction of defocus based on an image signal obtained from an imaging unit. The display control apparatus reduces the amount of defocus per unit amount of movement around an in-focus point and increases the amount of defocus per unit amount of movement around a largely out-of-focus point depending on the degree of focus.

In recent years, subjects in captured images to be detected by a subject detection function have increased in variety to include not only the face or the eye of a person but also an animal, such as a dog, a cat, and a bird, a vehicle, and other types of subjects. When the focus state is displayed during the subject detection, the responsiveness and stability may be affected depending on a subject or a part of the subject that is detected.

### SUMMARY OF THE DISCLOSURE

The present disclosure has been made in consideration of the above situation, and provides a display control apparatus capable of presenting a guide display showing the degree of focus with sufficient responsiveness and stability, a method for controlling the display control apparatus, and a storage medium.

According to an aspect of the present disclosure, a display control apparatus includes one or more processors that execute a program stored in a memory and thereby function as: a display control unit that performs control such that a live view image being captured by an imaging unit is displayed and such that a display item indicating a degree of focus is superimposed on the live view image; a detection unit capable of detecting a plurality of parts of a subject in the live view image; an acquisition unit that acquires a focus detection result for a focus detection region corresponding to a position at which the display item is displayed; and a changing unit that changes a display mode of the display item based on the focus detection result acquired by the acquisition unit. The display control unit changes, a responsiveness with which the display item is displayed in accordance with a part detected by the detection unit.

Further features of the present disclosure will become apparent from the following description of exemplary embodiments with reference to the attached drawings.

### BRIEF DESCRIPTION OF THE DRAWINGS

FIG. 1 is a block diagram illustrating the structure of a digital camera.

FIG. 2 is a flowchart of an imaging process.

FIGS. 3A, 3B, and 3C illustrate the structure of an imaging element.

FIG. 4 illustrates the manner in which a pupil is divided.

FIG. 5 illustrates a focus detection region.

FIG. 6 schematically illustrates the arrangement of pixels in the focus detection region.

FIGS. 7A, 7B, and 7C respectively illustrates examples of an image signal waveform, a correlation amount waveform, and a correlation shift waveform.

FIG. 8 illustrates an imaging optical system.

FIG. 9 is a flowchart of a focus detection operation.

FIG. 10 is a flowchart of a reliability evaluation operation.

FIGS. 11A, 11B, 11C, and 11D illustrate examples of focus guides that are displayed.

FIG. 12 is a flowchart of a focus-guide-displaying operation.

FIGS. 13A, 13B, and 13C illustrate examples of focus guides displayed during subject detection.

FIG. 14 is a flowchart of an operation of calculating the amount of defocus for focus guide display items according to a first embodiment.

FIGS. 15A to 15E illustrate examples of focus guide that are displayed according to a second embodiment.

FIG. 16 is a flowchart of an operation of determining a focus guide display mode according to the second embodiment.

FIG. 17 illustrates examples of focus guide display modes according to the second embodiment.

FIG. 18 is a flowchart of an operation of calculating the amount of defocus for focus guide display items according to a third embodiment.

FIGS. 19A and 19B illustrate examples of focus guide display modes.

### DESCRIPTION OF THE EMBODIMENTS

Exemplary embodiments of the present disclosure will now be described in detail with reference to the accompanying drawings.

In the embodiments described below, the present disclosure is applied to an imaging device, such as a digital camera. However, an imaging function is not essential for the present disclosure, and the present disclosure is applicable to any display control apparatus. Examples of the display control apparatus include computer devices (e.g., personal computers, tablet computers, media players, and PDAs), mobile phones, smart phones, game consoles, robots, drones, and dashboard cameras. These are examples, and the present disclosure may be applied to other electronic devices.

### First Embodiment

### Overall Structure

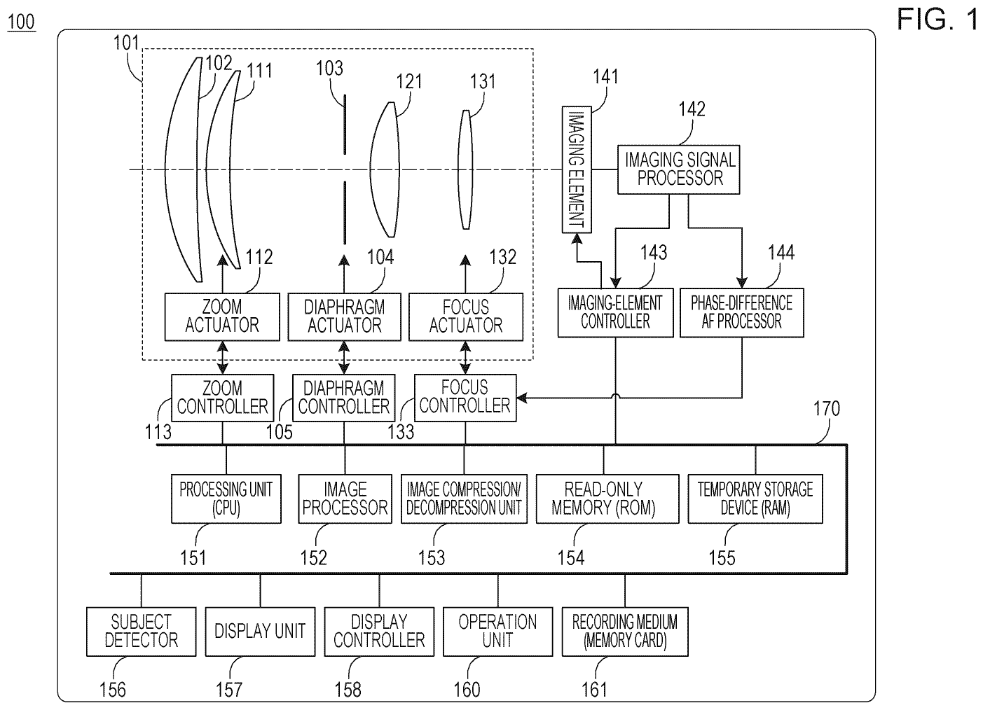

FIG. 1 illustrates an example of the structure of a digital camera 100, which is an example of a display control apparatus according to the present disclosure.

The digital camera 100 includes components connected to each other by a bus 170 and controlled by a main central processing unit (CPU) 151. The digital camera 100 includes an imaging element 141 including a plurality of photoelectric conversion elements that share one microlens. The digital camera 100 performs focus detection by a phase-difference detection method (imaging-surface phase-difference detection method) using an image signal output by the imaging element.

An imaging lens 101 is a lens unit including an imaging optical system including a first fixed lens group 102, a zoom lens 111, a diaphragm 103, a second fixed lens group 121, and a focusing lens 131. A diaphragm controller 105 drives the diaphragm 103 by using a diaphragm actuator 104 in response to an instruction from the CPU 151, and thereby adjusts an opening diameter of the diaphragm 103 to adjust the amount of light when an image is captured. A zoom controller 113 drives the zoom lens 111 by using a zoom actuator 112 to change the focal length. A focus controller 133 drives a focusing lens 131 by using a focus actuator 132 to control a focus state. Although the focusing lens 131, which is a focus adjustment lens, is schematically illustrated as a single lens in FIG. 1, the focusing lens 131 is typically composed of a plurality of lenses. Although the imaging lens 101 is integrated in the digital camera 100 in FIG. 1, the imaging lens 101 may be removably attachable to the digital camera 100.

A subject image formed on the imaging element 141 by light rays that pass through the imaging optical system is converted into an electric signal by the imaging element 141. The imaging element 141 is a photoelectric conversion device that converts a subject image (optical image) into an electric signal by photoelectric conversion. The imaging element 141 includes light-receiving elements arranged in m pixels in the horizontal direction and n pixels in the vertical direction, and each light-receiving element includes two photoelectric conversion elements (light-receiving regions) as described below. The electric signal obtained as a result of photoelectric conversion of the subject image formed on the imaging element 141 is processed by an imaging signal processor 142 as an image signal (image data or a captured image).

A phase-difference AF processor 144 acquires image signals (signal values) from the two photoelectric conversion elements (a first photoelectric conversion element and a second photoelectric conversion element) of each of the pixels included in the imaging element 141 through the imaging signal processor 142. A user operates on an operation unit 160 to set a focus detection region by changing or selecting the focus detection region. Alternatively, a subject detector 156 detects the position and size of a subject including a part of a person, an animal, or the like from the image data and sets the focus detection region based on the result of the detection. Alternatively, a display unit 157 may have a touch panel screen that enables the user to specify the subject or the focus detection region by performing a touch operation. Light from the subject in the set focus detection region is divided to obtain images for which an image shift in the dividing direction is detected (calculated).

Based on the detected image shift, the phase-difference AF processor 144 calculates a shift (amount of defocus) of the imaging lens 101 in the focusing direction. The amount of defocus can be calculated by multiplying the image shift by a coefficient (conversion coefficient). The operations of calculating the image shift and the amount of defocus are performed under instructions from the CPU 151. These operations may be at least partially performed by the CPU 151 or the focus controller 133.

The phase-difference AF processor 144 outputs the calculated amount of defocus to the focus controller 133. The focus controller 133 determines the amount by which the focus actuator 132 is to be driven based on the amount of defocus. The focus controller 133 and the focus actuator 132 control the movement of the focusing lens 131 to perform automatic focus adjustment control (autofocus control). In contrast, the user operates the operation unit 160 to perform manual focus adjustment control (manual focus control). The focus controller 133 controls the focusing lens 131 by using the focus actuator 132 in accordance with the amount of operation. The amount of operation may be, for example, the amount by which a ring-shaped operation member provided on the outer periphery of the lens is rotated; the time for which a lever-shaped operation member is operated; an amount by which a focus-adjusting operation member displayed on a touch panel is operated; or an amount by which the focus-adjusting operation member is pressed. At this time, a display controller 158 causes the display unit 157 to display image data output by the imaging signal processor 142 together with a focus guide in a superimposed manner. The focus guide is determined based on the amount of defocus calculated by the phase-difference AF processor 144.

The display of the focus guide will be described in detail below.

The image data output by the imaging signal processor 142 is transmitted to an imaging-element controller 143, temporarily stored in a temporary storage device (RAM) 155, compressed by an image compression/decompression unit 153, and then recorded in a recording medium 161, such as a memory card. In the present embodiment, the captured image data is image data that has undergone pupil division obtained by performing photoelectric conversion on each of a pair of image light rays of the subject separated from each other on an exit pupil plane.

In parallel with the above process, the image data stored in the RAM 155 is transmitted to an image processor 152. The image processor 152 (image processing unit) processes an image signal obtained by using a composite signal of the first and second photoelectric conversion elements. For example, the image processor 152 reduces or enlarges the image data to an optimum size. The image data processed to have the optimum size is transmitted to the display unit 157 (display), which displays the image. Thus, the user can observe the captured image in real time. When an image is captured, the display unit 157 may display the captured image immediately for a predetermined time to allow the user to check the captured image.

The subject detector 156 performs a known subject detection on the image data stored in the RAM 155 or the image data subjected to the image processing by the image processor 152, and thereby detects the size and the position of each region of, for example, the face, the eye, the entire body, or a part of a person, an animal, or the like. Here, assume that the part to be detected is any of the face, the eye, the head, the torso, the upper body, or the entire body. When the face is detected, the orientation of the face (front, side, or back) is also detected. In the following description, animals (a dog and a cat) are described as a detection subject other than a person. However, examples of the detection subject also include vehicles, such as an automobile (the entire body or a helmet), a motorcycle (the entire body or a person's head) a bicycle (the entire body or a person's head), a train (the entire body or the lead vehicle), an airplane, a helicopter (the entire body, the front, or the cockpit). Other examples of the detection subject include a bird, a horse, an insect, and a drone.

The operation unit 160 is an operation member that allows the user to provide instructions to the digital camera 100. The operation unit 160 may be, for example, an operation switch for controlling an imaging operation, an operation ring or an operation lever for controlling a focus adjustment operation, or a focus adjustment operation member displayed on the display unit 157 and operated directly on the display unit 157. The operation instruction signal input through the operation of the operation unit 160 is transmitted to the CPU 151 through the bus 170.

The imaging-element controller 143 receives instructions regarding an accumulation time for the image sensor 141 and the value of a gain to be output from the image sensor 141 to the imaging signal processor 142, and controls the image sensor 141 under instructions from the CPU 151.

A read-only memory (ROM) 154 stores control programs necessary for the operation of the digital camera 100. When the digital camera 100 is activated (changed from a power-off state to a power-on state) in response to an operation by the user, the control programs stored in the read-only memory ROM 154 are read (loaded) into a portion of the RAM 155. The CPU 151 controls the operation of the digital camera 100 in accordance with the control programs loaded into the RAM 155.

### Description of Manual Focus Adjustment Operation

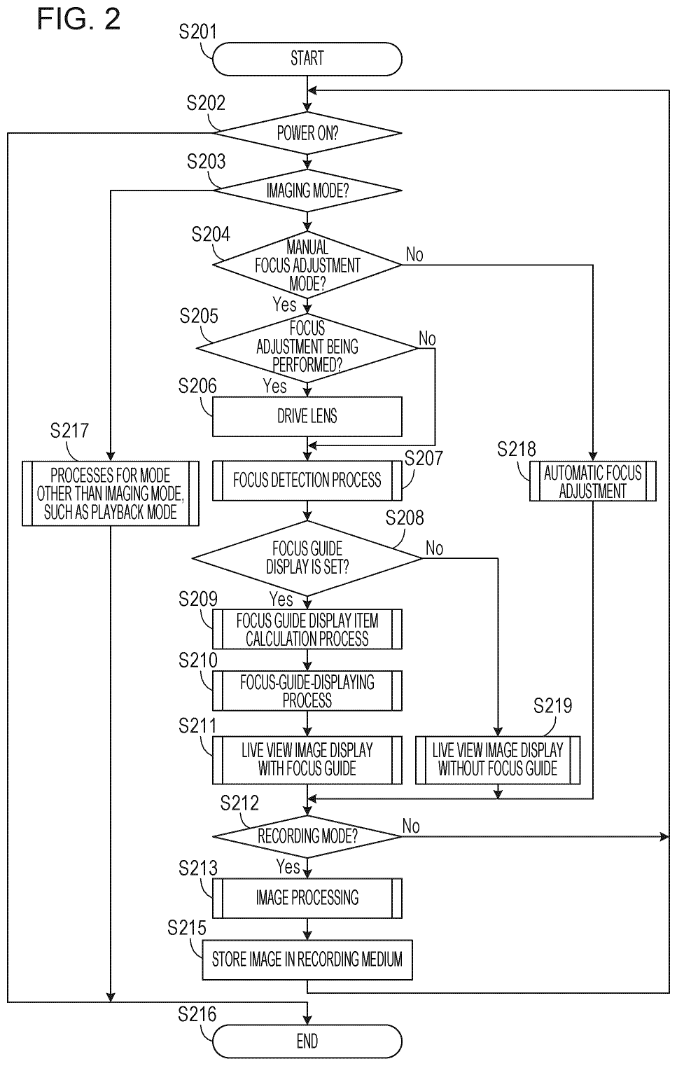

A manual focus adjustment operation including displaying of a focus guide will now be described with reference to FIG. 2. The processes of steps S201 to S216 are performed by the CPU 151.

First, in step S201, an imaging operation of a focus detection device is started. Then, the procedure proceeds to step S202.

Next, in step S202, it is determined whether or not the power of the digital camera 100 is on. When the power is on, the procedure proceeds to step S203. When the power is off, the procedure proceeds to step S216, and the imaging operation ends.

In step S203, an operation mode of the digital camera 100 is determined.

When the operation mode is an imaging mode, the procedure proceeds to step S204. When the operation mode is a mode other than the imaging mode (for example, a playback mode), the procedure proceeds to step S217, and necessary processes are performed. Then, the procedure returns to step S202.

In step S204, it is determined which of a manual focus adjustment mode and an automatic focus adjustment mode is set. When the manual focus adjustment mode is set, the procedure proceeds to step S205. When the manual focus adjustment mode is not set (when the automatic focus adjustment mode is set), the procedure proceeds to step S218, in which automatic focus adjustment is performed. After the automatic focus adjustment is completed, the procedure proceeds to step S212.

In step S205, it is determined whether the user is performing manual focus adjustment by using the operation member of the operation unit 160. When the manual focus adjustment is not performed, the procedure proceeds to step S207. When the manual focus adjustment is performed, the procedure proceeds to step S206.

In step S206, the amount of operation of the operation unit 160 is detected and temporarily stored in the RAM 155. The amount of operation may be, for example, the amount by which a ring-shaped operation member is rotated; the time for which a lever-shaped operation member is operated; an amount by which a focus-adjusting operation member displayed on a touch panel is operated; or an amount by which the focus-adjusting operation member is pressed. Subsequently, the focus controller 133 controls the focus actuator 132 based on an instruction from the CPU 151. The focus controller 133 acquires, from the RAM 155, the detected amount of operation of the manual focus adjustment and calculates a lens driving amount for driving the focusing lens 131 based on the amount of operation. The calculation of the lens driving amount includes calculations of a lens driving direction and a lens driving speed. Subsequently, the focus controller 133 controls the focus actuator 132 to drive the focusing lens 131 in accordance with the calculated driving direction, driving speed, and driving amount.

Next, in step S207, focus detection is performed for a focus detection region determined based on the position of a focusing frame selected by the user. Alternatively, the subject detector 156 detects the position and size of a subject including a part of, for example, a person or an animal from the image data, and the focus detection is performed for a focus detection region determined based on the result of the detection. The focus detection process will be described in detail below.

Next, in step S208, it is determined whether focus guide display is set. When the focus guide display is not set, the procedure proceeds to step S219. In step S219, based on instructions from the CPU 151, the display controller 158 acquires a live view image stored temporarily in step S207 from the RAM 155, and transmits the acquired image to the display unit 157, which displays the image. When the focus guide display is set, the procedure proceeds to step S209.

In step S209, a process of calculating an amount of defocus for focus guide display items is performed based on the focus detection result (amount of defocus and reliability evaluation) obtained in the focus detection process performed in step S207. This calculation process will also be described below.

Subsequently, in step S210, a focus-guide-displaying process is performed, and the procedure proceeds to step S211. The focus-guide-displaying process will be described below. In step S211, based on instructions from the CPU 151, the display controller 158 acquires, from the RAM 155, the live view image created in step S211 on which the focus guide is superimposed. Then, the display controller 158 transmits the acquired image to the display unit 157, which displays the image. While the processes from step S202 to S212 described below are repeated, the user performs the manual focus adjustment and drives the lens to an in-focus position. When a moving image is to be captured, the user operates the operation unit 160 to start capturing the image.

In step S212, it is determined whether an imaging start button (REC), which corresponds to the operation unit 160, is pressed and a recording mode is started. When the imaging start button is not pressed, the procedure proceeds to step S202, and the above-described processes of S202 to S211 are repeated. When the imaging start button is pressed, the procedure proceeds to step S213.

In step S213, image processing and related data processing are performed. The imaging control described in the above description of the structure of the focus detection device is performed, and the display controller 158 causes the display unit 157 to display the captured image. The captured image is also temporarily stored in the RAM 155.

In step S215, the captured image temporarily stored in the RAM 155 is read out and stored in the recording medium 161, such as a memory card. Subsequently, the procedure returns to step S202.

The above-described processes are repeatedly performed until it is determined that the power of the focus detection device is off in step S202.

### Focus Detection by Imaging-Surface Phase-Difference Detection Method

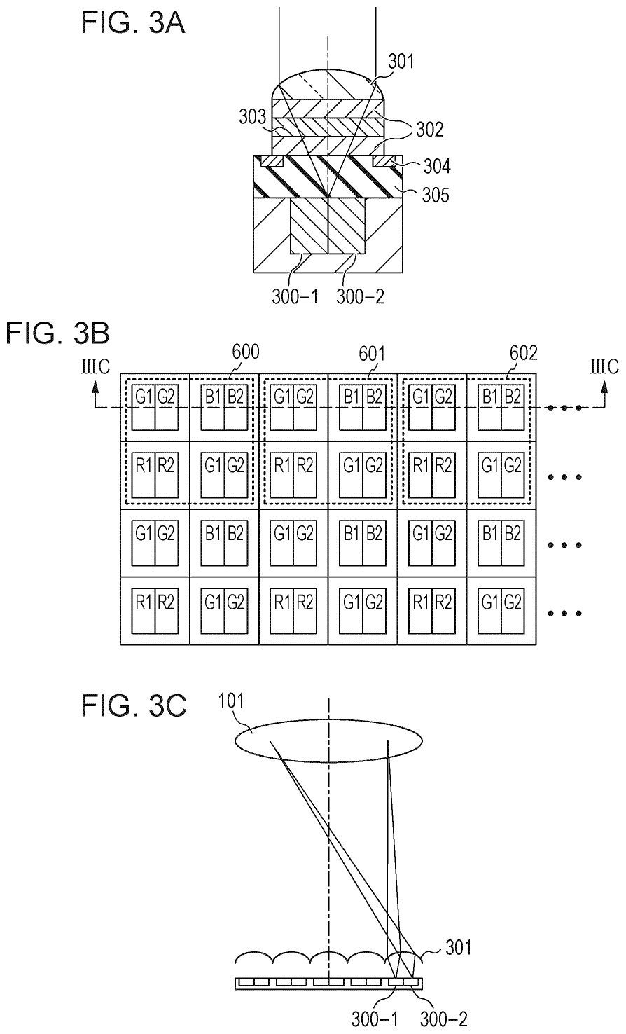

Focus detection by a phase-difference detection method according to the present embodiment will now be described. The structure of the imaging element 141 capable of outputting an image signal used for the focus detection by the phase-difference detection method will be described with reference to FIGS. 3A to 3C.

FIG. 3A is a block diagram (sectional view) of a pixel of the imaging element 141 having a pupil-dividing function.

A photoelectric conversion unit 300 of each pixel is divided into two photoelectric conversion elements: a photoelectric conversion element 300-1 (first photoelectric conversion element) and a photoelectric conversion element 300-2 (second photoelectric conversion element). Thus, the pupil-dividing function is provided. A microlens 301 (on-chip microlens) has a function of efficiently causing light to converge on the photoelectric conversion unit 300, and is disposed so that an optical axis thereof is on the boundary between the photoelectric conversion elements 300-1 and 300-2. Thus, in each pixel, two photoelectric conversion elements 300-1 and 300-2 are provided for one microlens 301. Each pixel also includes planarizing layers 302, a color filter 303, wires 304, and an interlayer insulating film 305. The number of elements into which the photoelectric conversion unit 300 of each pixel is divided may be greater than two.

FIG. 3B is a diagram (plan view) illustrating a portion of a pixel array included in the imaging element 141. The imaging element 141 is formed by arranging a plurality of pixels having the structure illustrated in FIG. 3A. In addition, to capture an image, red (R), green (G), and blue (B) color filters 33 are sequentially arranged in the respective pixels. Pixel blocks 600, 601, and 602, each of which includes four pixels, are arranged to form a Bayer arrangement. In FIG. 3B, the numbers “1” and “2” attached to the letters R, G, and B respectively correspond to the photoelectric conversion elements 300-1 and 300-2.

FIG. 3C is an optical principle diagram of the imaging element 141, and illustrates a portion of a sectional view of FIG. 3B taken along line IIIC-IIIC. The imaging element 141 is disposed on a planned imaging plane of the imaging optical system included in the imaging lens 101. Due to the effect of the microlens 301, the photoelectric conversion elements 300-1 and 300-2 receive a pair of light rays that pass through the pupil (exit pupil) of the imaging lens 101 at different positions (regions).

Each photoelectric conversion element 300-1 mainly receives a light ray that passes through the right region of the pupil of the imaging lens 101 in FIG. 3C. Each photoelectric conversion element 300-2 mainly receives a light ray that passes through the left region of the pupil of the imaging lens 101 in FIG. 3C.

### Principle of Pupil of Imaging Lens

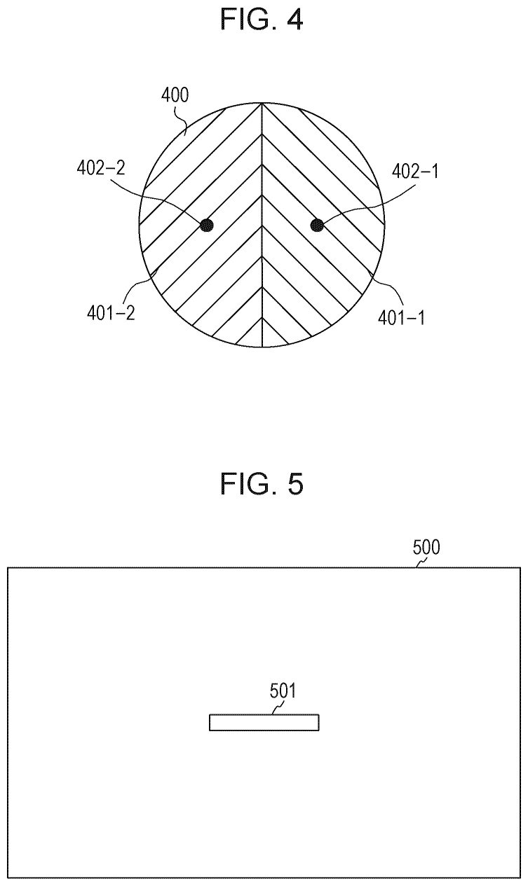

The pupil of the imaging lens 101 will be described with reference to FIG. 4. FIG. 4 illustrates a pupil 400 of the imaging lens 101 viewed from the imaging element 141.

FIG. 4 illustrates a sensitive region 401-1 (hereinafter referred to as an image-A pupil) corresponding to the photoelectric conversion element 300-1 and a sensitivity region 401-2 (hereinafter referred to as an image-B pupil) corresponding to the photoelectric conversion element 300-2. FIG. 4 also illustrates a centroid 402-1 of the image-A pupil and a centroid 402-2 of the image-B pupil.

In an imaging process, an image signal can be generated by combining outputs of two photoelectric conversion elements in which color filters of the same color are disposed in the same pixel.

In addition, in a focus detection process, a focus detection signal for each pixel block is acquired by accumulating outputs from photoelectric conversion elements corresponding to the photoelectric conversion elements 300-1 in the pixel block. This signal is acquired successively from the pixel blocks 600, 601, 602, and so on arranged in the horizontal direction to generate an image-A signal.

Similarly, a focus detection signal for each pixel block is acquired by accumulating outputs from photoelectric conversion elements corresponding to the photoelectric conversion elements 300-2 in the pixel block. This signal is acquired successively from the pixel blocks arranged in the horizontal direction to generate an image-B signal. Thus, in the imaging element of the present embodiment, each microlens includes the first and second photoelectric conversion elements, and the first and second photoelectric conversion elements output a pair of image signals corresponding to the focus state of the imaging optical system.

### Description of Focus Detection Region

FIG. 5 illustrates a focus detection region used in a focus detection method according to the present embodiment. As illustrated in FIG. 5, a focus detection region 501 is provided at an appropriate position in an imaging angle of view 500. The phase-difference AF processor 144 performs the focus detection by generating a pair of phase-difference detection signals in the focus detection region 501. A plurality of focus detection regions may be set in the imaging angle of view 500. In the present embodiment, each of the pixels included in the imaging element 141 includes two photoelectric conversion elements, and the phase-difference detection signals are generated in the focus detection region. However, this does not imply any limitation. For example, the imaging element 141 may include the structure illustrated in FIG. 3A (structure in which each pixel is divided) only in the focus detection region.

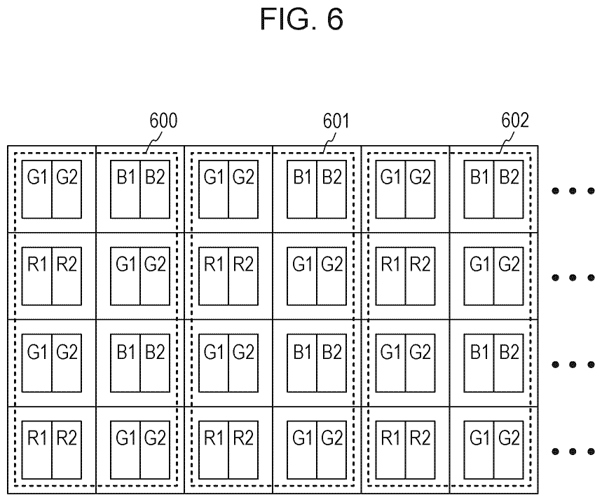

In the present embodiment, as illustrated in FIG. 6, image signals from the pixel blocks arranged in the vertical direction in FIG. 6 over an appropriate range are combined (brightness line combination) for use in the focus detection. In the example illustrated in FIG. 6, two pixel blocks arranged in the vertical direction in the Bayer arrangement are added and averaged to generate an image signal used for the focus detection. The number of pixel blocks to be subjected to the brightness line combination may be set as appropriate.

As the number of pixel blocks subjected to the brightness line combination increases, the size of the focus detection region 501 in the imaging angle of view 500 increases in the vertical direction.

### Image Shift Between Two Image Signals

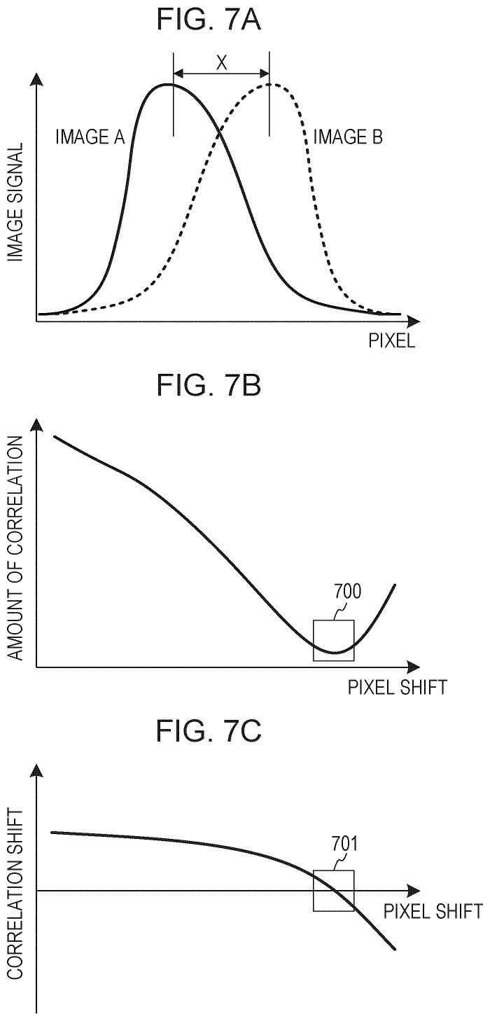

The image-A signal and the image-B signal (hereinafter referred to as also image signals) will now be described with reference to FIGS. 7A and 7B.

FIG. 7A is a graph illustrating the image signals. The vertical axis represents the signal level of the image signals, and the horizontal axis represents the pixel position. An image shift X between the pair of image signals for the phase-difference detection varies in accordance with the imaging state (in-focus state, front focus state, or back focus state) of the imaging lens 101.

When the imaging lens 101 is in the in-focus state, the image shift between the two image signals is 0. When the imaging lens 101 is in the front focus state or the back focus state, the image shift occurs in different directions. The image shift X has a certain correlation with the amount of defocus, which is the distance between the position at which the subject image is formed by the imaging lens 101 and the upper surface of the microlens.

To calculate the image shift X, the phase-difference AF processor 144 performs a correlation calculation on the two image signals. In the correlation calculation, the amount of correlation between the two image signals is calculated while the pixel is shifted, and the difference between the positions at which the correlation is highest is calculated as the image shift X.

FIG. 7B is a graph illustrating the waveform obtained by plotting the amount of correlation Cor(k) between the two image signals at each shift position (amount of shift) (k) when the pixel of the image signals is shifted (hereinafter referred to as a correlation amount waveform). In FIG. 7B, the horizontal axis represents the pixel shift position (k), and the vertical axis represents the amount of correlation Cor(k) between the image-A signal and the image-B signal at the shift position (k). The focus adjustment is performed by determining the amount of defocus of the imaging lens from the image shift X and calculating the lens driving amount for bringing the imaging lens into the in-focus state.

Conversion from Image shift to Amount of Defocus

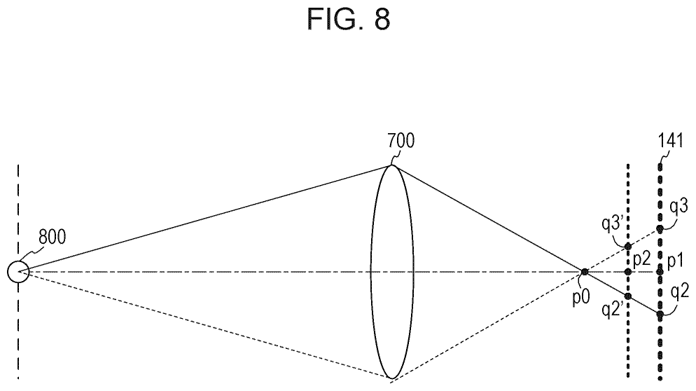

The conversion from the image shift determined by the correlation calculation to the amount of defocus will be described with reference to FIG. 8. FIG. 8 illustrates an optical system including the imaging lens 101 and the imaging element 141.

Referring to FIG. 8, a position p1 of a focus detection plane is on an optical axis passing through a position p0 of the planned imaging plane for a subject 800. The relationship between the image shift and the amount of defocus is determined by the optical system. The amount of defocus is calculated by multiplying the image shift X by a predetermined coefficient K (conversion coefficient).

The coefficient K is calculated based on the centroid positions of the image-A pupil and the image-B pupil. When the focus detection plane moves from the position p1 to a position p2, the image shift varies in accordance with the similarity between the triangle formed by positions p0, q2, and q3 and the triangle formed by positions p0, q2′, and q3′. The coefficient K can be used to calculate the amount of defocus of the focus detection plane at the position p2. The CPU 151 calculates the position of the focusing lens 131 (driving amount) for bringing the subject into focus based on the amount of defocus.

### Focus Detection Process

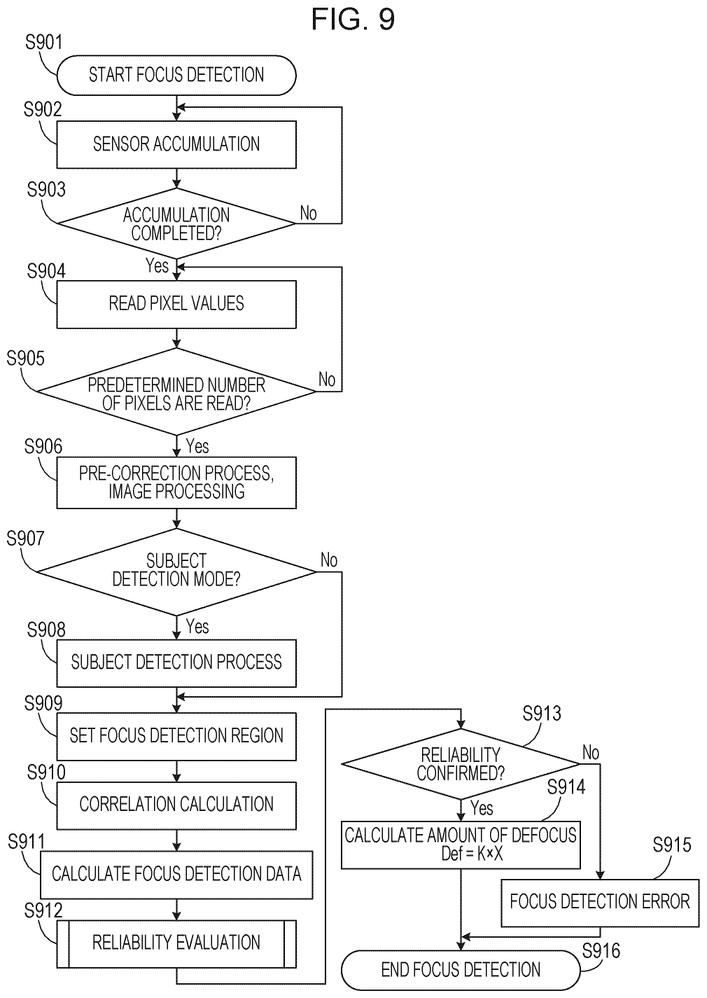

The focus detection process according to the present embodiment will be described with reference to FIG. 9. FIG. 9 is a flowchart of the focus detection process performed in step S207 in FIG. 2. The CPU 151 executes a control program and controls each component to carry out the steps in FIG. 9.

First, the focus detection is started in step S901.

Next, in step S902, the CPU 151 and the imaging-element controller 143 control the imaging element 141 and causes the imaging element 141 to perform charge accumulation (exposure) for a predetermined accumulation time. In step S903, the procedure waits for the accumulation to be completed, and proceeds to step S904 when it is determined that the accumulation is completed.

In step S904, the imaging-element controller 143 receives imaging signals from the imaging element 141 and transmits the acquired imaging signals to the imaging signal processor 142 under instructions from the CPU 151. The imaging signal processor 142 performs a predetermined process (image process) on the imaging signals generated by photoelectric conversion, and thereby generates image signals. Subsequently, the imaging-element controller 143 acquires the image signals (live view image) from the imaging signal processor 142, and temporarily stores the image signals in the RAM 155. Additionally, the CPU 151 controls the phase-difference AF processor 144 and causes the phase-difference AF processor 144 to read the image signals in the focus detection region from the imaging signal processor 142 and temporarily store the obtained image signals in the RAM 155.

Next, in step S905, the CPU 151 determines whether or not signals corresponding to a predetermined number of pixels are read for the live view display, the focus detection process, and a subject detection process. After signals corresponding to the predetermined number of pixels are read, the procedure proceeds to step S906.

In step S906, the image processor 152 performs a pre-correction process on the image signals.

The pre-correction process includes a correction process performed on the image signals that have been read out and filter processes performed on the image signals using, for example, an averaging filter and an edge-emphasizing filter. The image processor 152 also acquires a live view display image from the RAM 155, performs predetermined image processing, and temporarily stores the processed image in the RAM 155. The display controller 158 causes the display unit 157 to display the live view display image in step S211 or S219 described above. The image processor 152 also acquires an image for the subject detection process in the subject detector 156 from the RAM 155, performs predetermined image processing, and temporarily stores the processed image in the RAM 155.

In step S907, the CPU 151 determines whether the digital camera 100 is in a subject detection mode. For example, the determination is performed based on the setting in the menu displayed on the display unit 157. When the subject detection mode is on, the CPU 151 proceeds to step S908. When the subject detection mode is off, the CPU 151 proceeds to step S909. In addition to determining whether the subject detection mode is on or off, it is also determined whether the subject to be detected is a person (including the face or the eye) or not a person (for example, an animal). In this embodiment, the operation of detecting an animal will be mainly described.

In step S908, the subject detection process is performed. The subject detector 156 acquires the temporarily stored image for the subject detection from the RAM 155, and performs a known subject detection process. In addition, the subject detector 156 temporarily stores information including the type, size, and position of each of the detection subjects and the detection reliability in the RAM 155. In the present embodiment, an animal will be mainly described as the subject to be detected. In this case, parts of the subject are detected in the order of the entire body, the face, and the eye. Therefore, when the eye of an animal is detected, the face and the entire body of the animal have already been detected. There is no case in which only the eye and the entire body of an animal are detected.

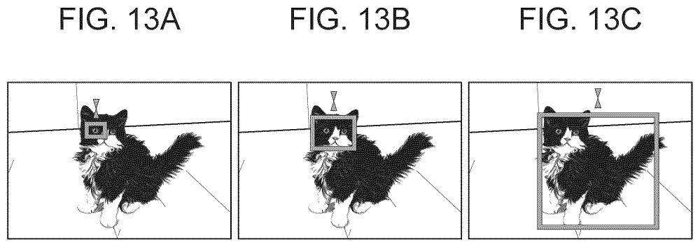

In step S909, the focus detection region is set. When it is determined that the subject detection mode is on in step 907, the CPU 151 acquires the subject detection information temporarily stored in the RAM 155. When the subject detection information for a plurality of subjects is present, the CPU 151 determines one of the subjects as the main subject, and causes the display controller 158 and the display unit 157 to display a focus guide at the position of the main subject in accordance with the size of the detection subject. When the subject detection information is for only one subject, the subject is determined as the main subject, and the focus guide is displayed in a manner similar to that in the case where a plurality of detection subjects is present. When the subject detection mode is off, the user operates the operation unit 160 to move the focus guide to the subject or the position to be brought into focus in the angle of view. The size and position of this focus guide (detection subject) are set as the focus detection region. When the size of the focus guide (detection subject) is large, or greater than a predetermined size of the focus detection region, a plurality of focus detection regions may be set to cover the entire region of the detection subject. A focus guide display mode described below may be determined from the focus detection results in the plurality of focus detection regions. The relationship between the size and position of the detection subject and the focus detection regions when the focus guide is displayed will be described with reference to FIGS. 13A, 13B, and 13C. FIG. 13A illustrates the focus guide displayed when the part of the detection subject is the eye of an animal (cat). FIG. 13B illustrates the case in which the part of the detection subject is the face of the animal, and FIG. 13C illustrates the case in which the part of the detection subject is the entire body of the animal. When the part of the detection subject is the eye of an animal, the subject detection region and the focus detection regions have the same size or similar sizes. However, the focus detection regions are set at positions shifted from the eye of the animal in the region surrounding the eye to enable continuous focus detection when the detected subject slightly moves. When the part of the detection subject is the face of an animal, the size of the focus detection regions is proportional to the size of the subject detection region, and is greater than that in the case of the eye but smaller than the subject detection region. If a single large focus detection frame is set, a shift of the focus detection region from the subject may result in the inclusion of the background and cause problems such as perspective conflict, leading to a failure in obtaining the expected focus detection result. Therefore, plural focus detection regions that are smaller than the subject detection region are set and arranged at positions shifted around the detected face of the animal beyond the area of the displayed focus guide. When the part of the detection subject is the entire body of an animal, similarly to the case of the face of the animal, focus detection regions smaller than the subject detection region are arranged at positions shifted to cover the entire body of the animal.

In step S910, the CPU 151 performs the correlation calculation on the image signals, and determines the image shift X by calculating the amount of shift at which the correlation is highest based on the calculated amount of correlation. The calculation of the image shift includes sub-pixel calculation using correlation values of the amount of shift at which the correlation is highest and the preceding and subsequent amounts of shift, and an interpolation value of less than pixel shift unit is calculated. The sum of the amount of shift and the interpolation value is the image shift X.

In step S911, the CPU 151 calculates focus detection data using any sub-pixel operational expression. Specifically, the image shift and an index for reliability evaluation, such as a two-image similarity index or a correlation change, is calculated.

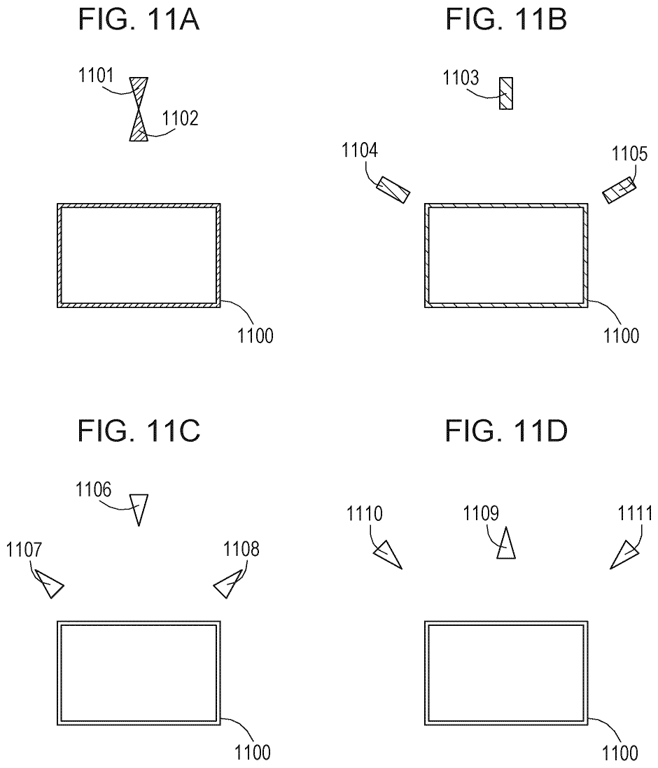

In step S912, the CPU 151 performs reliability evaluation in which the reliability of the calculated image shift X is evaluated. The reliability evaluation is performed based on a reliability evaluation value calculated when the focus detection data is calculated in step S911. The reliability evaluation will be described in detail below with reference to FIG. 11.

In step S913, the CPU 151 determines whether or not a reliable image shift X is obtained based on the result of the reliability evaluation. When it is determined that the reliability is confirmed, the CPU 151 calculates the amount of defocus Def in step S914 by multiplying the calculated image shift X by the coefficient K (by the relational expression Def=K×X). When the amount of defocus is calculated, a post-correction process may be performed to more precisely focus the imaging lens 101 on the subject. Subsequently, in step S916, the focus detection process ends and the procedure returns to the main routine from which the process was called.

When it is determined in step S913 that no reliable image shift is obtained, it is determined in step S915 that the focus detection is NG. In this case, the focus adjustment by the phase-difference detection method is not performed. Subsequently, in step S916, the focus detection process ends and the procedure returns to the main routine from which the process was called.

### Calculation of Reliability Evaluation Value

In step S910, in addition to the image shift X, an evaluation value used in the reliability evaluation is also calculated from the image signal waveform and the correlation amount waveform. The calculation of the reliability evaluation value in the case where the amount of correlation is acquired as the accumulation of the difference between the two image signals will now be described. The calculation described below is an example, and the reliability evaluation value may be calculated by other methods.

The reliability may be defined based on the level of contrast of the subject, the similarity between the two image signals, and the correlation change at the point at which the similarity between the two images is highest. As an index representing the level of contrast of the subject, a peak-bottom value, which is the difference between the maximum value (peak value) and the minimum value (bottom value), is calculated based on the image signal waveform. The reliability increases as the peak-bottom value increases.

Referring to point 700 in FIG. 7B, the amount of correlation is at a minimum when the correlation between the two image signals is highest. At this point, the amount of correlation is the difference between the two image signals when the correlation between the two image signals is highest, and is expressed as a similarity index F between the two image signals. The similarity increases as the image similarity index decreases, and the reliability increases accordingly.

FIG. 7C illustrates the waveform obtained by plotting a correlation shift.

The correlation shift ΔCor is calculated from the difference between the amounts of correlation skipping one shift in the correlation amount waveform in FIG. 8B (by the relational expression ΔCor=Cor(k−1)−Cor(k+1)). In FIG. 7C, the horizontal axis represents the pixel shift position k, and the vertical axis represents the correlation shift ΔCor(k) at the pixel shift position k. As illustrated in FIG. 7B, the amount of correlation is at a minimum when the correlation between the two image signals is highest. Therefore, the correlation shift waveform has a point 701 at which the correlation shift changes from positive to negative. The amount of change in the correlation shift around the shift position k at which the correlation shift is 0 is calculated as the correlation change M at which the similarity between the two images is highest (by the relational expression M=|ΔCor(k−1)|+|ΔCor(k)|). The reliability increases as the calculated value increases.

### Reliability Evaluation

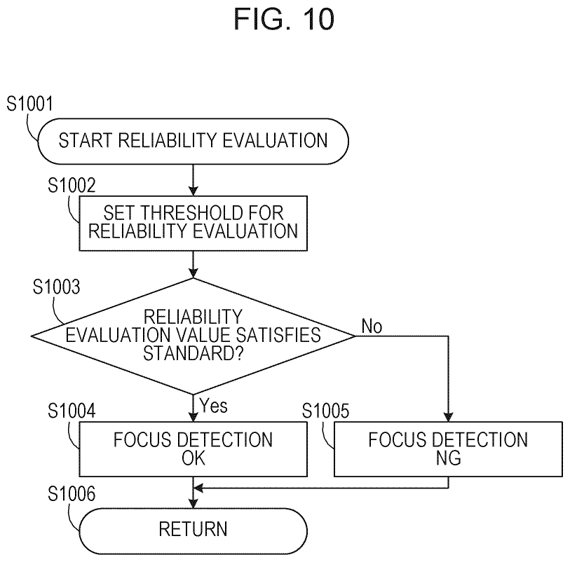

The reliability evaluation process performed in step S912 in FIG. 9 will be described with reference to FIG. 10. FIG. 10 is a flowchart of the reliability evaluation process based on the similarity index F of the two image signals in the present embodiment. The CPU 151 executes a control program and controls each component to carry out the steps in FIG. 10.

First, in step S1001, the reliability evaluation is started. In step S1002, the CPU 151 sets a threshold for the similarity index of the two image signals. The threshold may be, for example, a constant, such as 1000, or a dynamic value that depends on the focus detection conditions, such as the sensitivity of the imaging element or the brightness of the subject.

Next, in step S1003, the CPU 151 determines whether or not the reliability evaluation value (image similarity index F in this example) satisfies a predetermined level. When the predetermined level is satisfied, the procedure proceeds to step S1004, and it is determined that the focus detection is OK. When the predetermined level is not satisfied, the procedure proceeds to step S1005, and it is determined that the focus detection is NG.

After it is determined that the focus detection is OK or NG, in step S1006, the reliability evaluation process ends and the procedure returns to the main routine from which the process was called.

Although the reliability evaluation based on the image similarity index is described in detail herein, the reliability evaluation may be performed based on an index other than the image similarity index. For example, it may be determined whether or not the correlation change M satisfies the standard, whether or not the contrast of the image signal is sufficiently high, or whether or not the correlation calculation is not effective for the subject.

### Focus Guide Display Mode

The display mode of the focus guide in the present embodiment will now be described with reference to FIGS. 11A to 11D. In the present embodiment, the focus guide may be displayed in four modes, which are first to fourth display modes, and items 1101 to 1111 are used to show the detected focus state. The items 1101 to 1111 are disposed above a focusing frame 1100. The shape and size of the focusing frame 1100 vary in accordance with the setting of the focus detection device. For example, when the setting is such that a person or an animal is to be detected, the shape and size of the focusing frame 1100 are set in accordance with the part of the subject that is detected. When the setting is such that no detection is to be performed, the shape and size of the focusing frame 1100 are set in accordance with a focusing frame setting for the focus guide stored in the focus detection device.

FIG. 11A illustrates an example of the first display mode in which the subject is determined to be in focus. When the subject is determined to be in focus, an outwardly facing item 1101 and an inwardly facing item 1102 are at the same position (stopped in the upper region in this example). In addition, when the subject is determined to be in focus, for example, the items 1101 and 1102 may be displayed in a color (for example, green) different from a color (for example, white) in other display modes.

FIG. 11B illustrates an example of the fourth display mode in which the reliability of the focus detection result is low. In this case, neither the amount of defocus nor the direction of defocus is displayed so that the user visually recognizes that the focus detection cannot be performed. Here, the focusing frame 1100 and the items 1103 to 1105 are displayed in a color (for example, gray) different from the color in other display modes, and the items 1103 to 1105 are fixed at predetermined positions. In addition, the items 1103 to 1105 have shapes different from those in other display modes so that the user can more easily visually recognize that the focus detection is NG.

FIGS. 11C and 11D illustrate examples of the second display mode and the third display mode, respectively, in which the subject is not in focus but the reliability of the focus detection result is high. In this case, the direction toward the in-focus position (direction of defocus) and the amount of defocus are displayed.

FIG. 11C illustrates the state in which a region closer than the subject is in focus (front focus). An outwardly facing item 1106 is stopped in the upper region, and inwardly facing items 1107 and 1108 are symmetrically moved leftward and rightward along a circumference. The positions of the items 1107 and 1108 indicate the amount of defocus, and the amount of defocus increases as the items 1107 and 1108 move further away from the position of the item 1106 (reference position). The item 1106 corresponds to the item 1101, and the items 1107 and 1108 in an overlapping state correspond to the item 1102.

FIG. 11D illustrates the state in which a region farther than the subject is in focus (back focus). An inwardly facing item 1109 is stopped in the upper region, and outwardly facing items 1110 and 1111 are symmetrically moved leftward and rightward along a circumference. The positions of the items 1110 and 1111 indicate the amount of defocus, and the amount of defocus increases as the items 1110 and 1111 move further away from the position of the item 1109 (reference position). The item 1109 corresponds to the item 1102, and the items 1110 and 1111 in an overlapping state correspond to the item 1101.

As described above, in the second and third display modes, the amount of defocus can be indicated by the positions of the moving items. In addition, the direction of defocus can be indicated by the orientation of the item stopped in the upper region.

The manners in which the focus guides are displayed in FIGS. 11A to 11D are examples, and the present disclosure is not limited to this.

### Focus-Guide-Displaying Process

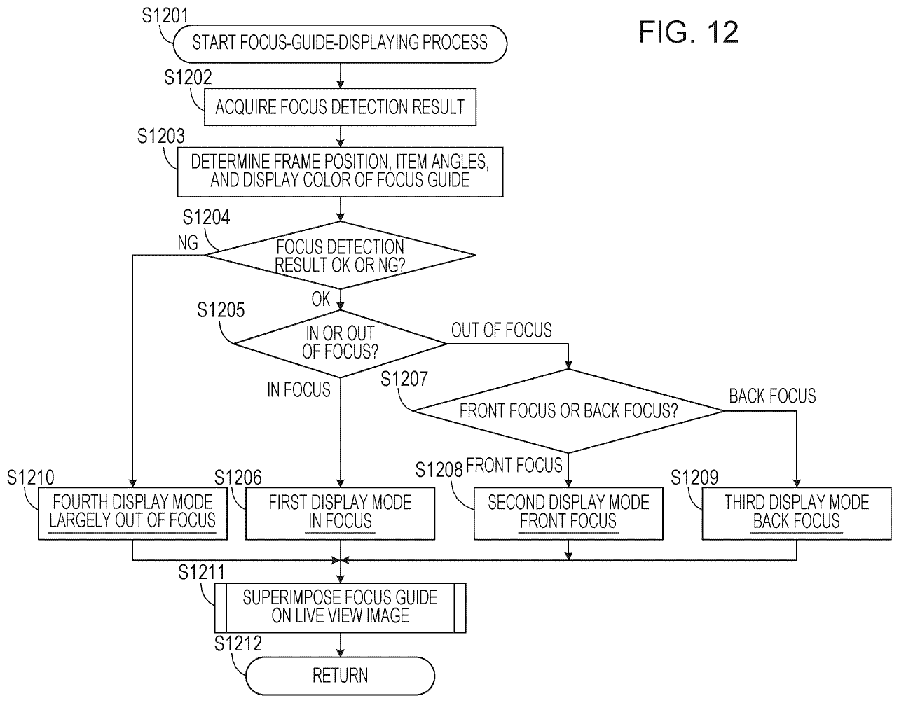

The focus-guide-displaying process of the present embodiment will now be described with reference to FIG. 12.

First, in step S1201, the CPU 151 starts the focus-guide-displaying process.

Next, in step S1202, the CPU 151 acquires the focus detection result stored in the RAM 155 in the focus detection process performed in step S207. Among the information on the focus detection result, the information used specifically in the focus-guide-displaying process includes the focus information for the subject corresponding to the focus position and whether or not the focus detection has succeeded. The focus information includes information on whether the subject is in focus or in front or back focus, and also includes information on the distance between the in-focus position and the subject when the subject is in front or back focus.

Next, in step S1203, the CPU 151 determines, based on the focus detection result acquired in step S1202, the frame position, the item angles, and the display color for the components of the focus guide to be displayed on the display unit 157.

Next, in step S1204, the CPU 151 determines whether the focus detection has succeeded or failed based on the focus detection result acquired in step S1202. When the focus detection has succeeded, the CPU 151 proceeds to step S1205. When the focus detection has failed, the CPU 151 proceeds to step S1210.

In step S1205, the CPU 151 determines whether the subject is in or out of focus based on the focus detection result acquired in step S1202. When the subject is in focus, the CPU 151 proceeds to step S1206. When the subject is out of focus, the CPU 151 proceeds to step S1207.

Subsequently, in step S1207, the CPU 151 determines whether the subject is in front focus or back focus based on the focus detection result acquired in step S1202. When the subject is in front focus, the CPU 151 proceeds to step S1208. When the subject is in back focus, the CPU 151 proceeds to step S1209.

In step S1206, the CPU 151 selects data corresponding to the first display mode, which is the display mode to be set when the subject is in focus. An example of this display mode is illustrated in FIG. 11A described above.

In step S1208, the CPU 151 selects data corresponding to the second display mode, which is the display mode to be set when the subject is in front focus. An example of this display mode is illustrated in FIG. 11C described above.

In step S1209, the CPU 151 selects data corresponding to the third display mode, which is the display mode to be set when the subject is in back focus. An example of this display mode is illustrated in FIG. 11D described above.

In step S1210, the CPU 151 selects data corresponding to the fourth display mode, which is the display mode to be set when the subject is largely out of focus. An example of this display mode is illustrated in FIG. 11B described above.

Finally, in step S1211, the CPU 151 performs a process of superimposing the focus guide on the live view image. The CPU 151 acquires the live view image captured and temporarily stored in the RAM 155 in the focus detection process performed in step S207 described above. The CPU 151 superimposes the data selected in step S1206, S1208, S1209, or S1210 on the live view image based on the display position, the item angles, and the display color determined in step S1203. Subsequently, the CPU 151 temporarily stores the live view image on which the focus guide is superimposed in the RAM 155.

Description of Change in Averaging Number of Focus Detection Results Depending on Part of Subject that is Detected

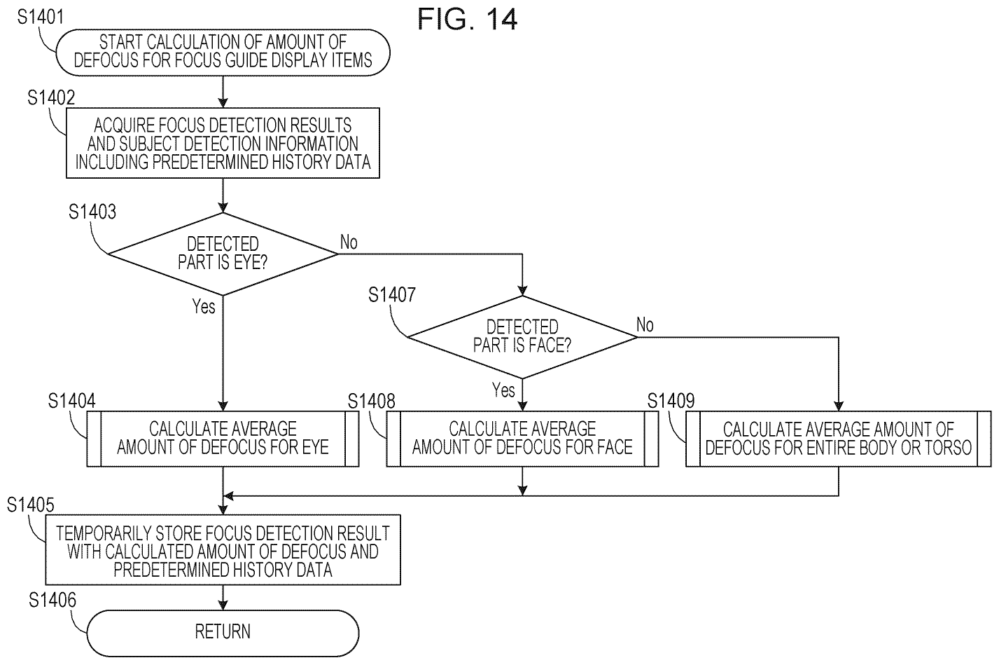

The method of changing the averaging number of focus detection results (amounts of defocus) depending on the part of the subject that is detected will now be described with reference to FIGS. 13A to 13C and FIG. 14 based on a flowchart of the process of calculating the amount of defocus for the focus guide display items. The process of steps 1401 to S1409 is performed by the CPU 151.

FIGS. 13A, 13B, and 13C respectively illustrate the focus guides displayed for the eye, the face, and the entire body as a detection part of an animal (cat).

First, in step S1401, the process of calculating the amount of defocus for the focus guide display items is started.

Next, in step S1402, the focus detection result obtained and temporarily stored in the RAM 155 immediately before step S207 described above and a predetermined number of focus detection results obtained previously and temporarily stored in the RAM 155 in step S1405 described below are acquired. The subject detection information obtained and temporarily stored in the RAM 155 in step S908 is also acquired. Then, the procedure proceeds to step S1403. In this example, it is assumed that the averaging numbers of focus detection results (amounts of defocus) are three, four, and five (predetermined number of current and previous cycles) when the detection part of an animal is the pupil, the face, and the entire body (torso), respectively. The averaging number increases in the order of the eye, the face, and the entire body (or torso) of the animal. This is because when the manual focus detection operation is performed and when the subject is to be brought precisely into focus, the focus guide needs to be displayed timely to enable the observation of changes in the focus guide display.

In step S1403, detection subject information temporarily stored in the RAM 155 is acquired. Subsequently, it is determined whether the part of the detection subject is the eye of an animal according to the detection subject information. When the part of the detection subject is the eye of an animal, the procedure proceeds to step S1404. When the part of the detection subject is not the eye of an animal, the procedure proceeds to step S1407. Subsequently, in step S1407, it is determined whether or not the part of the detection subject is the face. When the part of the detection subject is the face, the procedure proceeds to step S1408. When the part of the detection subject is the entire body or torso (other than the eye or face) of an animal, the procedure proceeds to step S1409.

In step S1404, the average of the predetermined averaging number of focus detection results (amounts of defocus) is calculated. In this example, the averaging number is three, and the average of the latest focus detection result (amount of defocus) and two previous amounts of defocus is calculated. At this time, when the predetermined averaging number of focus detection results include a result for which the focus detection is NG, the average is calculated without using the data for which the focus detection is NG. After the calculation, the procedure proceeds to step S1405.

In step S1408, the averaging number of focus detection results (amounts of defocus) is set to correspond to the case in which the part of the detection subject is the face (four in this example), and the average of the focus detection results (amounts of defocus) is calculated.

In step S1409, the averaging number of focus detection results (amounts of defocus) is set to correspond to the case in which the part of the detection subject is the entire body or torso (five in this example), and the average of the amounts of defocus is calculated.

In step S1405, the focus detection result calculated in step S1404, S1408, or S1409 and the predetermined number of focus detection results acquired in S1402 are temporarily stored in the RAM 155 after excluding the oldest data is time series. Then, the procedure proceeds to step S1406. In step S1406, the procedure returns to the main routine.

According to the present embodiment, the method for calculating the focus detection result (amount of defocus) based on which the focus guide is displayed is changed depending on the part of the detection subject. However, the averaging number of focus detection results (amounts of defocus) may be changed depending on the movement or posture of the detection subject. For example, in the case of an animal, the responsiveness with which the items of the focus guide are displayed can be increased as the possibility of rapid movement increases and reduced as the possibility of rapid movement decreases, as in the order of a moving state, a standing position, a sitting position (lower body), a sitting position (entire body), and a lying position.

In addition, in the present embodiment, an animal (the eye, the face, or the entire body) was described as an example of the detection subject. Other examples include a person (the eye, the face, the entire body, the upper body, or the torso) and a vehicle (local part of the entire body). Depending on the part of the subject that is detectable, the responsiveness with which the focus guide is displayed may be prioritized for parts to be brought precisely into focus in the manual focus detection operation. In this case, the averaging number of focus detection results (amounts of defocus) is reduced for parts to be brought precisely into focus, and is increased for parts to be brought roughly into focus to increase the display stability of the focus guide.

In step S907, it is determined whether the subject detection mode is set based on the setting in the menu of the digital camera 100. It may additionally be determined whether the subject to be detected is a person or a subject other than a person including an animal. The averaging number of focus detection results (amounts of defocus) may be changed in accordance with the setting of the subject to be detected.

In step S909, the focus detection region is determined based on the subject detection information detected in step S908. The averaging number of focus detection results (amounts of defocus) may be changed in accordance with a variation in the position of the focus detection region in time series. For example, when the variation is large, it can be assumed that the subject detection result itself varies or that the subject itself is moving. In such a case, the variation in the focus detection result itself is expected to increase. In this case, the averaging number can be changed depending on which of the responsiveness and the stability of the focus guide display is to be prioritized. The averaging number of focus detection results (amounts of defocus) may also be changed in accordance with the size of the focus detection region. For example, when the size of the focus detection region is small, the total number of pixels used for focus detection is relatively small. When the size is large, the total number of pixels used for focus detection is relatively large. It is known that the variation in the focus detection result itself is relatively small when the total number of pixels used for focus detection is large. Therefore, the averaging number of focus detection results (amounts of defocus) can be reduced.

As described above, in the present embodiment, the averaging number of focus detection results (amounts of defocus) for the focus guide is changed in accordance with whether the part of the detection subject is the eye, the face, or the entire body of an animal. Accordingly, the responsiveness of the focus guide display can be changed, and the manual focus adjustment operation can be performed smoothly depending on the part to be brought into focus.

### Second Embodiment

In the first embodiment, the method for calculating the focus detection result (amount of defocus) for determining the focus guide display items is changed in accordance with the detected part of the detection subject. In a second embodiment, an in-focus width used to determine whether the in-focus state is established based on the focus detection result (amount of defocus) for determining the focus guide display items is changed in accordance with the detected part of the detection subject and the orientation of the part. In the present embodiment, elements similar to those in the first embodiment are denoted by the same reference signs, and description thereof is omitted.

The procedure from step S201 to step S219 in FIG. 2 is similar to that in the first embodiment. However, the process of calculating the amount of defocus for the focus guide display items in step S209 differs from that in the first embodiment. Therefore, this process will now be described.

Description of Change in in-Focus Width Depending on Part of Subject that is Detected

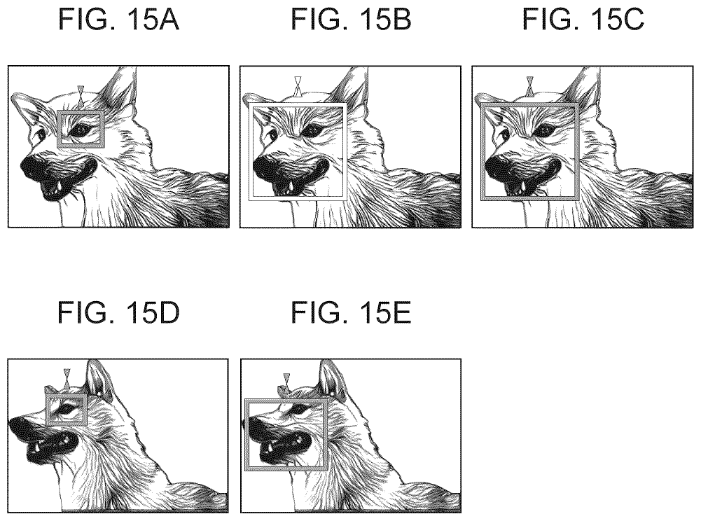

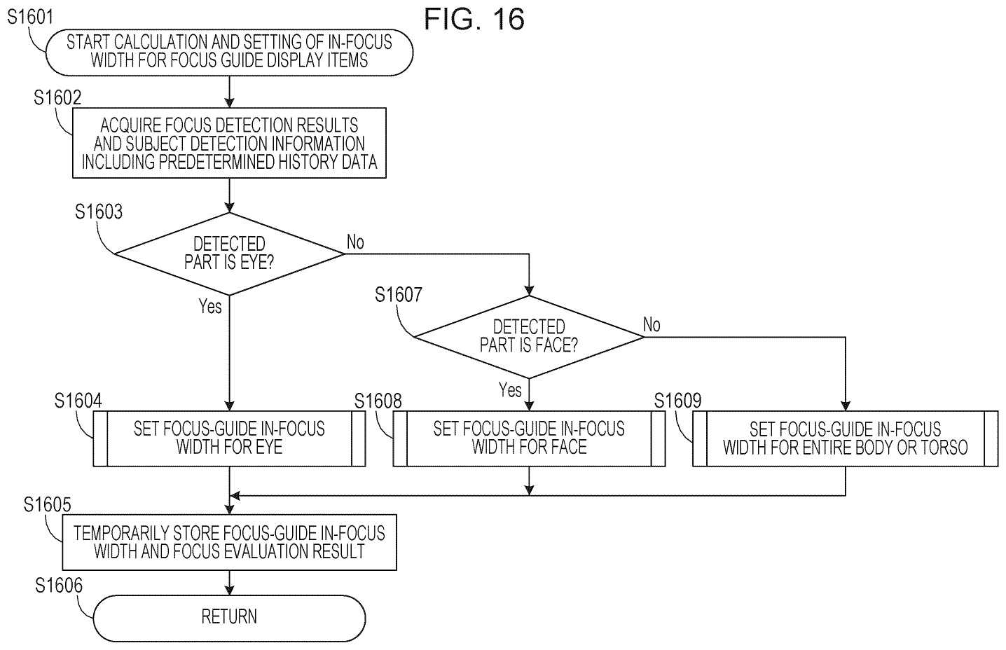

The method for changing the in-focus width will be described with reference to FIGS. 15A to 17. The in-focus width used to evaluate the focus detection result (amount of defocus) is changed in accordance with the detected part of the detection subject in the process of calculating the amount of defocus for the focus guide display items in step S209 in FIG. 2.

Referring to FIGS. 15A to 15E, the necessity of changing the in-focus width used to determine whether the in-focus state is established based on the amount of defocus to determine the focus guide display items according to the present embodiment will be described. FIG. 15A illustrates the state in which the focus guide is displayed on the eye of an animal (dog), and FIG. 15B illustrates the state in which the focus guide is displayed on the face of the animal (dog). Here, the detection result may vary depending on the type of the animal (including the shape of the face and the color of the fur) or the movement of the animal. When the detection result varies, the state illustrated in FIG. 15A and the state illustrated in FIG. 15B may be alternately repeated. If the difference in the focus detection result between the states illustrated in FIG. 15A and FIG. 15B is small and the in-focus display state of the focus guide is continued, the manual focus adjustment operation can be easily continued. If the states illustrated in FIG. 15A and FIG. 15B differ in the focus detection result, or if one corresponds to an in-focus display state while the other corresponds to an out-of-focus state, not only the size of the focus guide but also the state of the display items (color in the present embodiment) frequently changes.

Therefore, it is difficult to determine whether the in-focus state is established, and the manual focus detection adjustment is also difficult. Accordingly, even when the detection result somewhat varies, and even when the states of FIG. 15A and FIG. 15C are alternately repeated, the display of the items of the focus guide is maintained to facilitate the manual focus adjustment operation.

A procedure of the calculation process for the focus guide display items will be described with reference to FIG. 16. The processes of steps S1601 to S1609 are performed by the CPU 151.

First, in step S1601, the calculation process for the focus guide display items is started.

Next, in step S1602, the focus detection result obtained and temporarily stored in the RAM 155 immediately before step S207 described above and a predetermined number of focus detection results obtained previously and temporarily stored in the RAM 155 in step S1605 described below are acquired. The detection subject information obtained and temporarily stored in the RAM 155 in step S908 is also acquired. Then, the procedure proceeds to step S1603.

In step S1603, it is determined whether the part of the detection subject is the eye of an animal according to the detection subject information. When the part of the detection subject is the eye of an animal, the procedure proceeds to step S1604. When the part of the detection subject is not the eye of an animal, the procedure proceeds to step S1607. Subsequently, in step S1607, it is determined whether or not the part of the detection subject is the face. When the part of the detection subject is the face, the procedure proceeds to step S1608. When the subject to be detected is the entire body or torso (other than the eye or face) of an animal, the procedure proceeds to step S1609.

In step S1604, it is determined whether the in-focus state is established based on the focus detection result (amount of defocus) acquired in step S1602. Assuming that the threshold of the in-focus width is DefThA, the focus state is determined to be the in-focus state when the focus detection result (amount of defocus) is less than or equal to the in-focus width DefThA, and the out-of-focus state when the focus detection result (amount of defocus) is greater than the in-focus width DefThA.

In step S1608, the threshold of the in-focus width is set to DefThB, and a process similar to that in step S1604 is performed. The focus state is determined to be the in-focus state when the focus detection result (amount of defocus) is less than or equal to the in-focus width DefThB, and the out-of-focus state when the focus detection result (amount of defocus) is greater than the in-focus width DefThB. In step S1609, the threshold of the in-focus width is set to DefThC, and the focus state is determined to be the in-focus state when the focus detection result (amount of defocus) is less than or equal to the in-focus width DefThC and the out-of-focus state when the amount of defocus is greater than the in-focus width DefThC. In steps S1604, S1608, and S1609, the thresholds DefThA, DefThB, and DefThC of the in-focus width set in accordance with the part of the detection subject satisfy DefThA<DefThB<DefThC. In this example, the in-focus width is changed depending on whether the part of the detection subject requires precise focusing or only needs rough focusing. The threshold of the in-focus width is increased as the depth of the part of the detection subject increases.

In step S1605, the calculation result obtained in step S1604, S1608, or S1609 and the predetermined number of focus detection results acquired in S1602 are temporarily stored in the RAM 155 after excluding the oldest data in time series. Then, the procedure proceeds to step S1606. In step S1606, the procedure returns to the main routine.

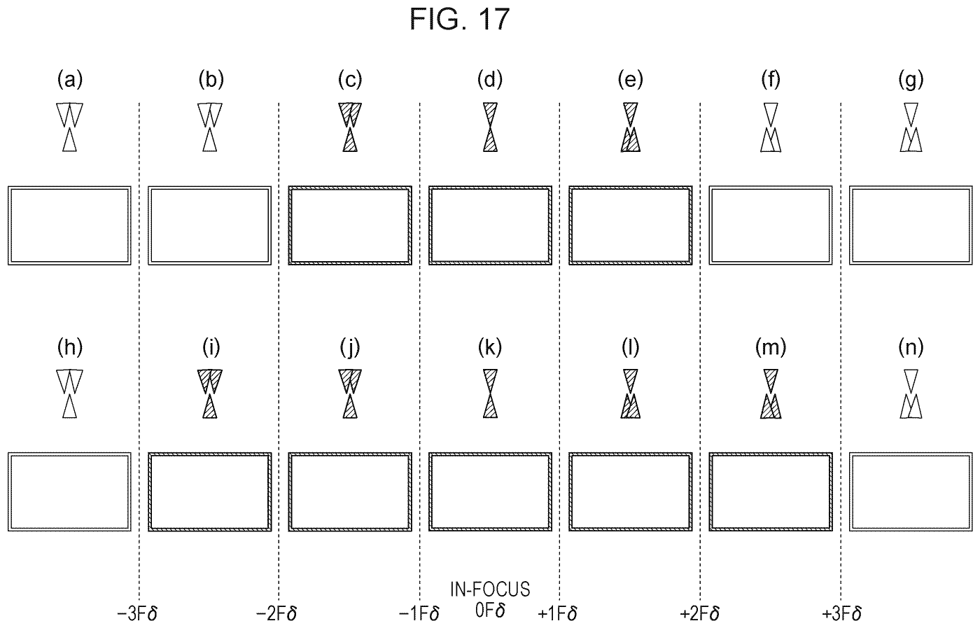

The display mode of the focus guide items when the in-focus width is changed will be described with reference to FIG. 17. In FIG. 17, (a) to (g) illustrate a case in which the detection subject is the eye of an animal and in which the threshold of the in-focus width is normal, and (h) to (n) illustrate a case in which the detection subject is the face of an animal and in which the threshold of the in-focus width is increased. When the part of the detection subject is the eye of an animal and the in-focus width is normal, in the present embodiment, the in-focus width is set to depth 2 (±2Fδ, where F is the f-number and δ is the permissible circle of confusion) and it is determined that the in-focus state is established when the focus detection result is within the in-focus width. Then, the display mode of the focus guide is set to that for the in-focus state, which is similar to the first display mode described with reference to FIG. 12 ((c) to (e) in FIG. 17). When the focus detection result (amount of defocus) is outside the in-focus width, the display mode is set to be similar to the second or third display mode described with reference to FIG. 12 ((a), (b), (f), and (g) in FIG. 17), and the angles of the display items are set in accordance with the focus detection result (amount of defocus). When the part of the detection subject is the face of an animal and the in-focus width is increased, in the present embodiment, the in-focus width is set to depth 3 (+3Fδ), and the display mode of the focus guide is set in accordance with the threshold similarly to the case in which the in-focus width is normal. When the in-focus width is increased, the focus guide is displayed in the first display mode in (i) to (m) in FIG. 17. Thus, in the present embodiment, when the part of the detection subject is the face of an animal, the in-focus width is increased compared to when the part of the detection subject is the eye of the animal, so that the display mode of the focus guide items can be continuously set to that for the in-focus state, as illustrated in (i) and (m) in FIG. 17.

As described above, in the present embodiment, the in-focus width, which is used to determine whether the in-focus state is established based on the amount of defocus to determine the display items of the focus guide, is changed in accordance with the detected part. Accordingly, even when the subject detection result varies, the stability of the display of the focus guide can be maintained. This allows the user to perform the manual focus adjustment operation smoothly without discomfort. In the present embodiment, the method for changing the in-focus width in accordance with the detected part, which may be the eye, the face, or the entire body of an animal, is described. However, the in-focus width may also be changed in accordance with the orientation or angle of the detected part. For example, in FIGS. 15D and 15E, in which the face of an animal (dog) is viewed from the side, the difference in the depth direction between the eye and the face of the animal is small. In this case, it is not necessary to increase the in-focus width for the face of the animal, and the stability of the display of focus guide items is maintained, so that the manual focus adjustment operation can be performed.

### Third Embodiment

In the present embodiment, unlike the case described in the first and second embodiments in which only an animal serving as the subject to be detected is present in the angle of view, it is assumed that both an animal, serving as the main subject, and a person (other than the main subject) are present within the same angle of view. A method for changing the averaging number of focus detection results (amounts of defocus) for determining the responsiveness of the focus guide display items depending on the positional relationship between the animal and the person will be described.

In the present embodiment, elements similar to those in the first and second embodiments are denoted by the same reference signs, and description thereof is omitted.

The procedure from step S201 to step S219 in FIG. 2 is similar to that in the first and second embodiments. However, the process performed in S209 differs from those in the first and second embodiments. This will now be described.

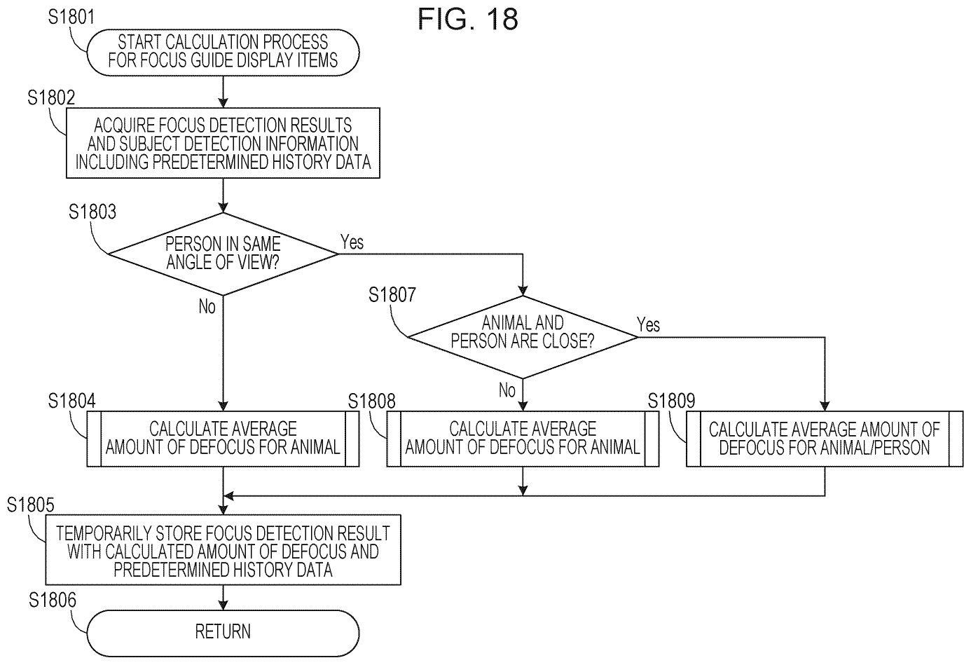

Referring to FIG. 18, a method for changing the averaging number of focus detection results (amounts of defocus) for determining the responsiveness of the focus guide display items when the animal serving as the main subject and a person (another subject) are in the same angle of view will now be described. The processes of steps S1801 to S1809 are performed by the CPU 151.

First, in step S1801, the calculation process for the focus guide display items is started.

Next, in step S1802, the focus detection result obtained and temporarily stored in the RAM 155 immediately before step S207 described above and a predetermined number of focus detection results obtained previously and temporarily stored in the RAM 155 in step S1805 described below are acquired. The subject detection information obtained and temporarily stored in the RAM 155 in step S908 is also acquired. Then, the procedure proceeds to step S1803.

In step S1803, it is determined whether a plurality of detection subjects are present and whether a person is in the same angle of view based on the detection subject information acquired in step S1802. When a single detection subject is present or when only animals are present in the angle of view, the procedure proceeds to step S1804. When a plurality of detection subjects are present and a person is in the same angle of view, the procedure proceeds to step S1807. In step S1807, the positional relationship between the animal serving as the main subject and the person in the same angle of view is determined. Specifically, the distance between the position of the detected animal and the position of the person is calculated, and when the distance is less than or equal to a predetermined value (range in which the animal and the person can be regarded as being close to each other), the procedure proceeds to step S1809. When it is determined that the distance is greater than the predetermined value, the procedure proceeds to step S1808.

In step S1804, it has been determined in step S1803 that the detection subject present in the angle of view is only one or more animals. Therefore, the process of averaging the focus detection results (amounts of defocus) is performed for when the detection subjects are animals, or in accordance with the part of the detection subject as described in the first embodiment. After the average of the focus detection results (amounts of defocus) is calculated, the procedure proceeds to step S1805.

In step S1808, it has been determined in step S1807 that the animal and the person in the same angle of view are distant from each other and therefore the relationship therebetween is weak, that is, that the movement of the animal is not affected by the person. Therefore, the process of averaging the focus detection results (amounts of defocus) is performed for when the detection subjects are animals, or in accordance with the part of the detection subject as described in the first embodiment. After the average of the focus detection results (amounts of defocus) is calculated, the procedure proceeds to step S1805.

In step S1809, it has been determined in step S1807 that the animal and the person in the same angle of view are close to each other and therefore the relationship therebetween is strong, that is, that the movement of the animal may be affected by the person. Therefore, the averaging process is performed after changing the averaging number of the focus detection results (amounts of defocus) for when the detection subjects are animals, or that corresponds to the part of the detection subject as described in the first embodiment, by adding a predetermined number or multiplying the averaging number by a predetermined factor. When the animal serving as the main subject is close to a person, the animal is less likely to move suddenly. Therefore, the stability of the focus guide display may be prioritized over the responsiveness to facilitate the manual focus adjustment operation. Subsequently, the average of the focus detection results (amounts of defocus) is calculated, and then the procedure proceeds to step S1805.

In step S1805, the calculation result obtained in step S1804, S1808, or S1809 and the predetermined number of focus detection results acquired in S1802 are temporarily stored in the RAM 155 after excluding the oldest data in time series. Then, the procedure proceeds to step S1806. In step S1806, the procedure returns to the main routine.

In the present embodiment, when an animal serving as the subject to be detected and a person (another subject) are in the same angle of view, the responsiveness of the display of the focus guide is determined in accordance with the positional relationship between the animal and the person. For this purpose, the averaging number of focus detection results (amounts of defocus) is changed. As a result, the manual focus adjustment operation can be performed while the responsiveness and stability of the display of the focus guide for the animal serving as the subject to be detected are both sufficient.

In the present embodiment, the averaging number of focus detection results (amounts of defocus) is changed in accordance with the positional relationship (distance) between the animal serving as the subject to be detected and the person in the same angle of view in the vertical and horizontal directions in the captured image. However, the averaging number may be changed in accordance with the positional relationship (distance) between the animal and the person in the depth direction.

The averaging number of focus detection results (amounts of defocus) in the focus detection region set for an animal serving as the subject to be detected may also be changed in accordance with the positional relationship between the animal and a part (face, hand, etc.) of the person in the same angle of view. When, for example, the face or hand of the person is close to the animal, the person is likely holding or petting the animal. Therefore, the animal serving as the main subject is unlikely to move suddenly or vigorously. Accordingly, the averaging number of focus detection results (amounts of defocus) may be increased to prioritize the stability over responsiveness of the display of the focus guide. In addition, when the subject detector 156 is capable of detecting the situation of the animal serving as the main subject and the person, the averaging number of focus detection results (amounts of defocus) may be changed in accordance with the situation. The situation may be, for example, a situation in which the person is holding the animal serving as the main subject or a situation in which the person is petting (touching) the animal serving as the main subject.

Although the first to third embodiments of the present disclosure have been described above, the present disclosure is not limited to the above-described embodiments, and various modifications and alterations are possible within the gist thereof.

For example, in the above-described embodiments, the front focus state and the back focus state are displayed such that the interval between the items indicate the amount of defocus. Alternatively, however, a frame indicating the focus state with a size corresponding to the amount of defocus may be additionally displayed. In this case, when the in-focus state is established, the focusing frame and the frame indicating the focus state are displayed in an overlapping manner. Also in this case, when it is determined that the in-focus state is established, the display color (for example, green) may be changed from the color (for example, white) for other display modes. When it is unclear whether the in-focus state is established, a display indicating that it is unclear may be displayed.

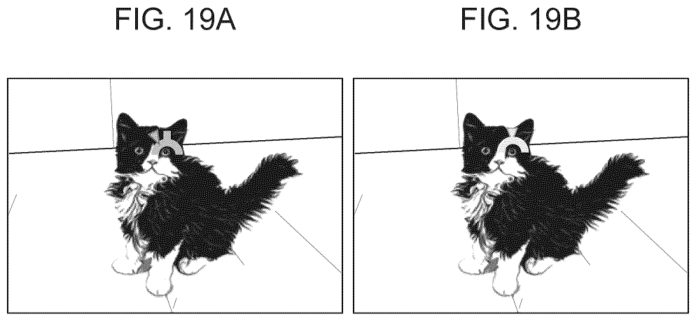

The present disclosure may also be applied to a display mode illustrated in FIGS. 19A and 19B, in which a bar showing the range form the front focus to the back focus, an item showing the current focus state, and an item showing the reference position (in-focus position) are shown.

According to the present embodiment, a guide display showing the degree of focus can be presented with sufficient responsiveness and stability.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-033088 filed Mar. 5, 2024, which is hereby incorporated by reference herein in its entirety.

What is claimed is:

1. A display control apparatus comprising;
one or more processors that execute a program stored in a memory and thereby function as:
a display control unit that performs control such that a live view image being captured by an imaging unit is displayed and such that a display item indicating a degree of focus is superimposed on the live view image;
a detection unit capable of detecting a plurality of parts of a subject in the live view image;
an acquisition unit that acquires a focus detection result for a focus detection region corresponding to a position at which the display item is displayed; and
a changing unit that changes a display mode of the display item based on the focus detection result acquired by the acquisition unit,
wherein the display control unit changes a responsiveness with which the display item is displayed in accordance with a part detected by the detection unit.

2. The display control apparatus according to claim 1, wherein the subject to be detected by the detection unit is an animal, and the plurality of parts includes at least two of a face, an eye, a head, and a body.

3. The display control apparatus according to claim 1, wherein the subject to be detected by the detection unit is a person, and the plurality of parts includes at least two of a face, an eye, a head, a torso, an upper body, and an entire body.

4. The display control apparatus according to claim 1, wherein the display control unit changes the responsiveness by changing an averaging number for calculating an average of the focus detection result.

5. The display control apparatus according to claim 4, wherein the display control unit changes an averaging number for calculating an average of the focus detection result in accordance with a position variation or a size of the focus detection region.

6. The display control apparatus according to claim 4, wherein the display control unit changes an averaging number for calculating an average of the focus detection result in accordance with a posture or a movement of the subject detected by the detection unit.

7. The display control apparatus according to claim 4, wherein, when the subject detected by the detection unit comprises a plurality of subjects, the display control unit changes an averaging number for calculating an average of the focus detection result in accordance with a relationship between a main subject and a detection subject other than the main subject.

8. The display control apparatus according to claim 7, wherein the relationship between the main subject and the detection subject other than the main subject is a distance between the main subject and the detection subject other than the main subject.

9. The display control apparatus according to claim 8, wherein, when the main subject is an animal and the detection subject other than the main subject is a person, the display control unit changes the averaging number for calculating the average of the focus detection result in accordance with a distance between a part of the person and the animal that is the main subject.

10. The display control apparatus according to claim 7, wherein, when the main subject is an animal and the detection subject other than the main subject is a person, the display control unit changes the averaging number for calculating the average of the focus detection result in accordance with a state of the person with respect to the animal that is the main subject.

11. The display control apparatus according to claim 10, wherein the state of the person other than the main subject with respect to the animal that is the main subject is a state of the person that affects a movement of the animal that is the main subject.

12. The display control apparatus according to claim 11, wherein the state of the person that affects the movement of the animal that is the main subject is at least one of a state in which the person is holding the animal and a state in which the person is petting the animal.

13. The display control apparatus according to claim 1, wherein the display control unit changes the responsiveness by changing an in-focus width for determining whether an in-focus state is established based on the focus detection result.

14. The display control apparatus according to claim 13, wherein the in-focus width for determining whether the in-focus state is established is changed in accordance with an orientation or an angle of the part detected by the detection unit.

15. A method for controlling a display control apparatus, the method comprising:
a display control step of performing control such that a live view image being captured by an imaging unit is displayed and such that a display item indicating a degree of focus is superimposed on the live view image;
a detection step in which a plurality of parts of a subject in the live view image is capable of being detected;
an acquisition step of acquiring a focus detection result for a focus detection region corresponding to a position at which the display item is displayed; and
a changing step of changing a display mode of the display item based on the focus detection result acquired in the acquisition step,
wherein, in the display control step, a responsiveness with which the display item is displayed is changed in accordance with a part detected in the detection step.

16. A computer-readable non-transitory storage medium that stores a program for causing a computer to execute the method according to claim 15.
